(19) United States
(12) Patent Application Publication
(10) Pub. No.: US 2011/0148715 A1
(43) Pub. Date: Jun. 23, 2011

(54) PATCH ANTENNA AND MINIATURIZING METHOD THEREOF

(75) Inventor: CHIH-YUAN YANG, Tu-Cheng (TW)

(73) Assignee: HON HAI PRECISION INDUSTRY CO., LTD., Tu-Cheng (TW)

(21) Appl. No.: 12/710,368

(22) Filed: Feb. 23, 2010

(30) Foreign Application Priority Data
Dec. 21, 2009 (CN) 200910311917.2

(51) Int. Cl. H01Q 1/38; H01P 11/00; H01Q 9/04

(52) U.S. Cl. 343/700 MS; 29/600

(57) ABSTRACT

A miniaturizing method for a patch antenna includes following steps: providing a patch antenna comprising a radiator; setting at least one through hole on the radiator to change the current distance of the patch antenna, the changed current distance being equal to an expected current distance; and forming a miniature patch antenna.

### BACKGROUND

1. Technical Field

The present disclosure relates to patch antennas, and particularly to a miniature patch antenna.

2. Description of Related Art

Antennas are essential components in wireless communication devices for sending and receiving electromagnetic waves. As wireless communication devices become smaller and smaller, associated patch antennas must reduce in size to accommodate the miniaturization of the wireless communication devices. However, as the size of the patch antenna changes, reception may become unstable and the frequency band also changes.

Therefore, there is room for improvement in the art.

### BRIEF DESCRIPTION OF THE DRAWINGS

The components of the drawings are not necessarily drawn to scale, the emphasis instead being placed upon clearly illustrating the principles of the embodiments of a miniature patch antenna. Moreover, in the drawings, like reference numerals designate corresponding parts throughout several views.

FIG. 1 is a schematic, isometric view of a patch antenna in accordance with an exemplary embodiment, including a coaxial cable.

FIG. 2 is a schematic, plane view of the coaxial cable of the patch antenna of FIG. 1.

FIG. 3 is a schematic, isometric view of a patch antenna in accordance with another exemplary embodiment.

FIG. 4 is a flowchart of a miniaturizing method for a patch antenna in accordance with an exemplary embodiment.

### DETAILED DESCRIPTION

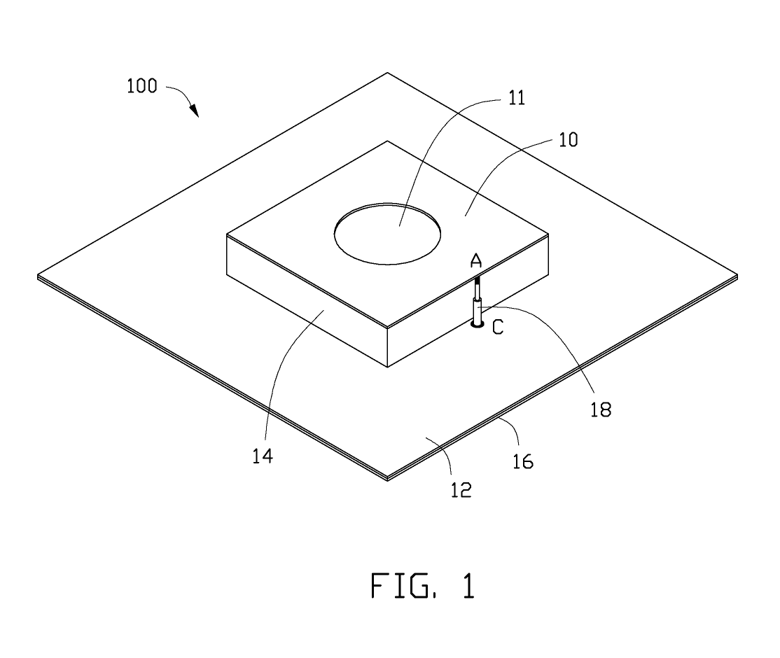

Referring to FIG. 1, a patch antenna 100 in accordance with one embodiment is illustrated. The patch antenna 100 may be used in an electronic device (not shown), such as a mobile phone, a personal digital assistant (PDA), and so on. The patch antenna 100 includes a radiator 10, a ground sheet 12, a dielectric substrate 14, an insulated substrate 16, and a feeding line 18.

The ground sheet 12 is parallel to the insulated substrate 16, and is attached on the insulated substrate 16. The ground sheet 12 is grounded. In other embodiments, the ground sheet 12 and the insulated substrate 16 together form a circuit board, such as a printed circuit board. The ground sheet 12 can be made of iron for reducing the manufacturing cost. However, it may be understood that the material of the ground sheet 12 may comprise other metallic materials, such as aluminum.

The dielectric substrate 14 is arranged between the ground sheet 12 and the radiator 10. The dielectric substrate 14 is configured for ensuring that the patch antenna 100 has a stable working frequency not substantially affected by temperature. In this embodiment, the dielectric substrate 14 is a hollow square structure. In other embodiments, the dielectric substrate 14 can be other hollow structures, such as a hollow cylindrical structure. The dielectric substrate 14 can also be atmosphere.

The radiator 10 is parallel to the insulated substrate 16. The radiator 10 is configured for transducing electromagnetic wave between the atmosphere and the electronic device. The radiator 10 receives electromagnetic waves from the atmosphere, and converts the electromagnetic waves to electrical signals which are received by the electronic device. The radiator 10 receives electrical signals from the electronic device, and transforms the electrical signals itto electromagnetic waves which are radiated into the atmosphere. The electrical signals are current signals.

A through hole 11 is defined in a center of the radiator 10. In other embodiments, two or more holes may be defined in the radiator 10. In this embodiment, the radiator 10 is rectangular and made of the same material as the ground sheet 12, and the through hole 11 is round. The radiator 10 is electrically connected to the feeding line 18, and a feeding portion A is formed at the electrical node of the radiator 10 and the feeding line 18. The feeding portion A is configured for transferring the current signals in and/or out of the radiator 10. In this embodiment, the feeding portion A is arranged on the edge of the dielectric substrate 14. The current signals from the feeding portion A is infused into the radiator 10 and flows along the radiator 10. Normally, the direction of the current flow is parallel to the edges of the radiator 10 that are to the right and left of the feeding portion A. However, due to the through hole 11 in the radiator 10, the current bends around the edge of the through hole 11. Thus, the patch antenna 100 can have a longer current distance even with a smaller dimension.

Consequently, a current distance of the patch antenna 100 is the same as that of a typical patch antenna, however, the patch antenna 100 is smaller than the traditional patch antenna.

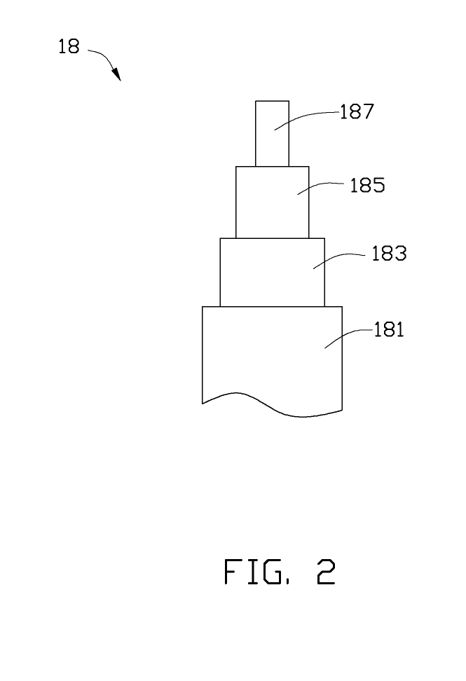

The feeding line 18 is configured for transferring signals between the radiator 10 and an electronic device (not shown). In this embodiment, the feeding line 18 is a coaxial cable. As shown in FIG. 2, the feeding line 18 includes a sheath 181, a cylindrical outer conductor 183, a cylindrical insulator 185, and a central conductor 187. The central conductor 187 lies in a center of the outer conductor 183. The outer conductor 183 and the central conductor 187 are insulated by the insulator 185. The outer conductor 183 is covered by the sheath 181. The central conductor 187 is electrically connected to the radiator 10 and the outer conductor 183 is electrically connected to the ground sheet 12.

In this embodiment, an electrical node between the central conductor 187 and the radiator 10 is the feeding portion A, an electrical node between the outer conductor 183 and the ground sheet 12 is a grounding portion C. The grounding portion C is set on the ground sheet 12. In this embodiment, the feeding line 18 runs through the ground sheet 12 and the insulated substrate 16 to be electrically connected to the electronic device. In other embodiments, the feeding line 18 can extend along the ground sheet 12 to be electrically connected to the electronic device.

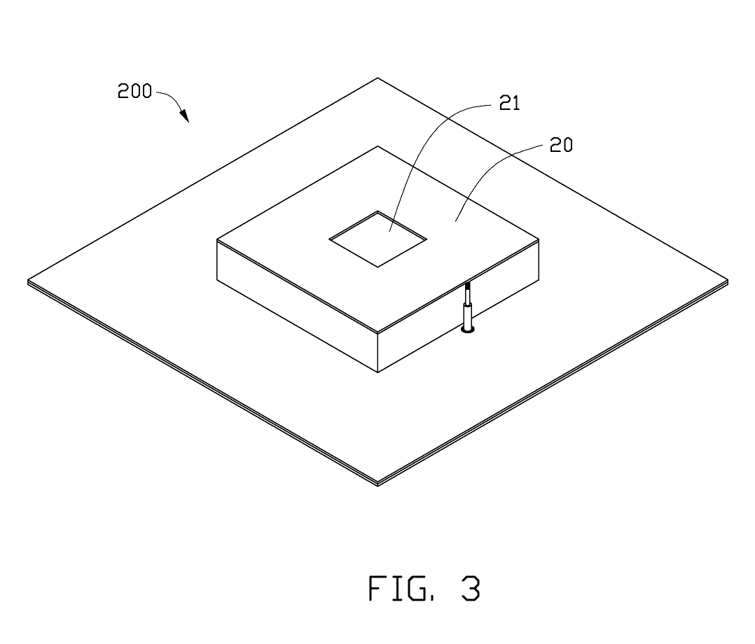

Under the same current distance, the through hole 11 can be other shapes and also can be bigger. As shown in FIG. 3, a patch antenna 200 in accordance with another embodiment is illustrated. The difference between the patch antenna 200 and the patch antenna 100 is that the patch antenna 200 includes a square through hole 21. The patch antenna 200 and the patch antenna 100 has the same current distance.

The current distances of the patch antenna 100 and the patch antenna 200 is the same as that of a typical patch antenna, however, the patch antenna 100 and the patch antenna 200 are smaller, and more miniature than the traditional patch antenna. The patch antenna 100, the patch antenna 200, and the traditional patch antenna maintain the same frequency.

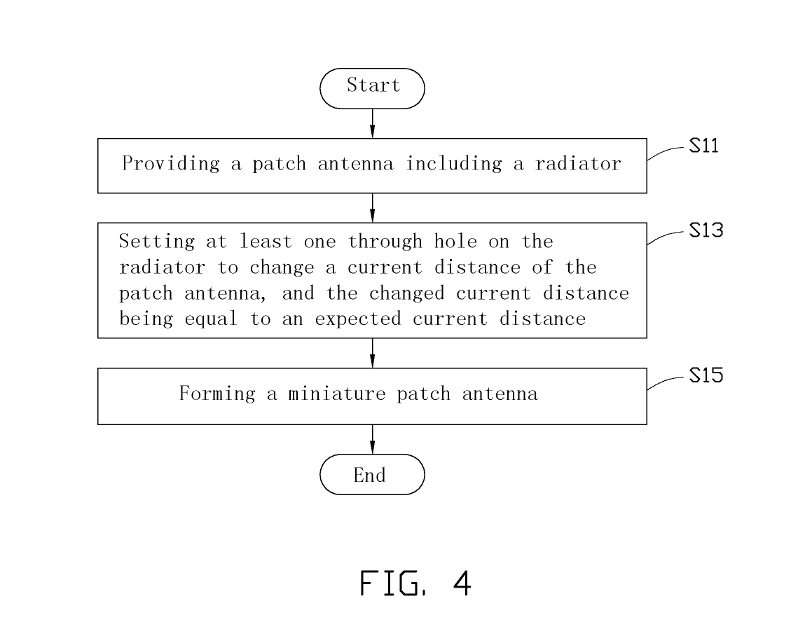

Referring to FIG. 4, a flowchart of a miniaturizing method for a patch antenna 100 in accordance with an exemplary embodiment is shown. The miniaturizing method shown includes the following steps.

In step S11, providing a patch antenna including a radiator.

In step S13, setting at least one through hole on the radiator to change a current distance of the patch antenna, and the changed current distance being equal to an expected current distance. The through hole can be a round hole or a square hole or other shapes.

In step S15, forming a miniature patch antenna.

In above steps, it can keep same current distance of the patch antenna and the miniature patch antenna, so the frequency of the miniature patch antenna can be the same as the regular patch antenna.

It is to be understood, however, that even though numerous has been described with reference to particular embodiments, but the present disclosure is not limited to the particular embodiments described and exemplified, and the embodiments are capable of considerable variation and modification without departure from the scope of the appended claims.

What is claimed is:

1. A patch antenna, comprising:
an insulated substrate;
a ground sheet attached on the insulated substrate, the ground sheet configured for being electrically grounded;
a radiator parallel to the insulated substrate, and configured for transducing electromagnetic wave signals, at least one through hole defined in the radiator to change a current distance of the patch antenna; and
a dielectric substrate arranged between the ground sheet and the radiator, the dielectric substrate configured for ensuring that the patch antenna has a stable working frequency not substantially affected by temperature.

2. The patch antenna of claim 1, wherein the at least one through hole is round.

3. The patch antenna of claim 1, wherein the at least one through hole is square.

4. The patch antenna of claim 1, wherein the dielectric substrate is a hollow structure.

5. The patch antenna of claim 1, wherein the dielectric substrate is atmosphere.

6. The patch antenna of claim 1, further comprising a feeding line coupled between the radiator and an electronic device, the feeding line comprising:
a cylindrical outer conductor electrically connected to the ground sheet;
a cylindrical central conductor lying in a center of the outer conductor, and electrically connected to the radiator;
a cylindrical insulator insulating the outer conductor from the central conductor; and
a sheath covered with the outer conductor.

7. The patch antenna of claim 6, wherein an electrical node between the central conductor and the radiator defines a feeding portion, and the feeding portion is set on the edge of the dielectric substrate.

8. The patch antenna of claim 6, wherein an electrical node between the outer conductor and the ground sheet defines a grounding portion.

9. The patch antenna of claim 1, wherein the ground sheet and the radiator are made of the same material.

10. The patch antenna of claim 9, wherein the ground sheet and the radiator are made of iron.

11. A patch antenna, comprising:
a circuit board configured for being electrically grounded;
a radiator parallel to the circuit board, and configured for transmitting and receiving electromagnetic wave signals, at least one through hole defined in the radiator to change a current distance of the patch antenna; and
a dielectric substrate arranged between the circuit board and the radiator, and the dielectric substrate configured for ensuring that the patch antenna has a stable working frequency not substantially affected by temperature.

12. The patch antenna of claim 11, wherein the circuit board is a printed circuit board.

13. The patch antenna of claim 11, wherein the at least one through hole is round.

14. The patch antenna of claim 11, wherein the at least one through hole is square.

15. A miniaturizing method for a patch antenna, comprising:
providing a patch antenna comprising a radiator;
setting at least one through hole on the radiator to change the current distance of the patch antenna, the changed current distance being equal to an expected current distance; and
forming a miniature patch antenna.

16. The miniaturizing method of claim 15, wherein the at least one through hole is round.

17. The miniaturizing method of claim 15, wherein the at least one through hole is square.
